(19) United States
(12) Patent Application Publication
(10) Pub. No.: US 2024/0249157 A1
(43) Pub. Date: Jul. 25, 2024

(54) SYSTEM AND METHOD FOR DEMOGRAPHICS/INTERESTS PREDICTION VIA JOINT MODELING

(71) Applicant: YAHOO ASSETS LLC, DULLES, VA (US)

(72) Inventors: Ivan Stojkovic, DULLES, VA (US); Jason Grigsby, DULLES, VA (US); Soomin Lee, DULLES, VA (US); Srinath Ravindran, DULLES, VA (US); Narayan Bhamidipati, DULLES, VA (US); Namita Raghavan, DULLES, VA (US)

(21) Appl. No.: 18/158,387

(22) Filed: Jan. 23, 2023

(51) Int. Cl. G06N 5/022

(52) U.S. Cl. CPC G06N 5/022

(57) ABSTRACT

The present teaching relates to method, system, medium, and implementations for joint prediction. Training data is obtained with information about a plurality of users collected from different sources and ground truth demographics/interests associated with each of the plurality users. Based on the training data, a joint prediction model is trained for simultaneously predicting multiple pieces of demographic/interest information. When information about a user from different sources is received, a joint feature vector is derived therefrom, which is then used by the trained joint prediction model to predict multiple pieces of demographic/interest information about the user.

### CROSS REFERENCE TO RELATED APPLICATION

The present application is related to U.S. patent application Ser. No. ______ (Attorney Docket No.: 146555.570841), filed on ______, entitled “SYSTEM AND METHOD FOR DEMOGRAPHICS/INTERESTS PREDICTION USING DATA FROM DIFFERENT SOURCES AND APPLICATION THEREOF”, the contents of which are hereby incorporated by reference in its entirety.

### BACKGROUND

### 1. Technical Field

The present teaching generally relates to computers. More specifically, the present teaching relates to data analytics and application thereof.

### 2. Technical Background

With the advancement of the Internet, much of the daily activities are conducted online through applications connecting to the network. Such activities include aspects of daily life, work, communication for social or for work, shopping, entertainment, hobbies, or schooling. Because of that, commercial activities are more and more planned and carried out around the network as well via various applications that offer different services/products to facilitate the population to take care of different aspects of their lives via network connections. Companies try to find out, via tracking online activities of users, their interests/preferences in order to expand the services and sell their products to more customers or to understand what aspects of their products/services need to be improved in order to retain their customers.

Traditionally, user demographics and/or interests may be made available by tracking and sharing user demographic information and monitored user activities for estimating users' or cohorts' interests for targeted advertisement. In recent years, due to concerns over privacy, demographic information for non-native users has become increasingly difficult to obtain and sharing of such data has also become more restrictive. As such, much of the information needed for targeting needs to be estimated. For instance, based on a user's first name, demographic information on gender may be estimated. Similarly, based on a user's identification (which may also include some information on the user's first name) may also be used to estimate the gender of the user. FIG. 1 illustrates a typical system 100 that targets users based on demographic information individually estimated based on data available on the Internet. System 100 may include a plurality of demographics information prediction engines, 110-1, 110-2, . . . , 110-K, each of which may rely on data from a corresponding source to estimate a particular piece of demographic information. For instance, demographic information prediction engine 1 110-1 may be provided to estimate whether a user belongs to a particular age group based on data from source 1, demographic information prediction engine 2 110-2 may be provided to estimate whether a user belong to a second age group based on data from source 2, . . . , and demographic information prediction engine K 110-K may be provided to estimate the gender of a user based on data from source K.

The estimated demographic information may then be utilized by a content targeting engine 120 to determine sending what content to which user located where in the country. The content may include advertisements each of which may be associated with a description as to its content. The content target engine 120 may be connected with a content consumer database 150 that may include a sub-population to which the content target engine 120 may recommend content, a content archive 130 which stores content to be recommended such as advertisements, and a regional demographics database 140 which may store information about demographics associated with different regions and statistics associated thereof. Information estimated from different demographic information prediction engines 110-1, . . . , 110-K may be used to update the content consumer database 150 and/or the regional demographics database 140 for targeting.

The traditional approach for predicting demographic information in a traditional system as shown in FIG. 1 is individual prediction, i.e., each prediction engine predicts one piece of information. This requires much resource, the operation is inefficient, and does not consider the interplay among data. Thus, there is a need for a solution that addresses the challenges discussed above.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for joint prediction. Training data is obtained with information about a plurality of users collected from different sources and ground truth demographics/interests associated with each of the plurality users. Based on the training data, a joint prediction model is trained for simultaneously predicting multiple pieces of demographic/interest information. When information about a user from different sources is received, a joint feature vector is derived therefrom, which is then used by the trained joint prediction model to predict multiple pieces of demographic/interest information about the user.

In a different example, a system is disclosed for joint prediction. A joint model based demographic/interest prediction engine is provided for learning a joint prediction model and for simultaneously predicting multiple pieces of demographic/interest information. Training data relating to multiple users is first obtained from different sources with ground truth demographics/interests associated with each of the users and then is used to train a joint prediction model via machine learning for simultaneously predicting multiple pieces of demographic/interest information. Once trained, the joint prediction model is used to predict/estimate demographics and/or interests of a user based on a joint feature vector constructed based on information about the user collected from different sources.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for joint prediction. The information, when read by the machine, causes the machine to perform the following steps. Training data is obtained with information about a plurality of users collected from different sources and ground truth demographics/interests associated with each of the plurality users. Based on the training data, a joint prediction model is trained for simultaneously predicting multiple pieces of demographic/interest information. When information about a user from different sources is received, a joint feature vector is derived therefrom, which is then used by the trained joint prediction model to predict multiple pieces of demographic/interest information about the user.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary traditional targeting system based on information predicted from tracked data;

FIG. 2A depicts an exemplary high level system diagram of a targeted content distribution system based on demographic/interest information predicted based on a joint model, in accordance with an embodiment of the present teaching;

FIG. 2B is a flowchart of an exemplary process of a targeted content distribution system based on demographic/interest information predicted based on a joint model, in accordance with an embodiment of the present teaching;

FIG. 3A illustrates exemplary types of data from different sources (DFDS) for joint model based prediction, in accordance with an embodiment of the present teaching;

FIG. 3B illustrates exemplary types of identification data from different sources used in joint model based prediction, in accordance with an embodiment of the present teaching;

FIG. 3C depicts an exemplary framework for generating embeddings for joint model based prediction and dynamic update thereof, in accordance with an embodiment of the present teaching;

FIG. 3D illustrates exemplary types of dynamic application usage data with respect to devices for joint model based prediction, in accordance with an embodiment of the present teaching;

FIG. 3E illustrates exemplary demographic information jointly predicted based on a joint prediction model, in accordance with an embodiment of the present teaching;

FIG. 4A depicts an exemplary high level system diagram of a joint model based demographic/interest prediction engine, in accordance with an embodiment of the present teaching;

FIG. 4B is a flowchart of an exemplary process of a joint model based demographic/interest prediction engine, in accordance with an embodiment of the present teaching;

FIG. 5A illustrates an exemplary high dimensional feature vector with attributes associated with different data types from different sources, in accordance with an embodiment of the present teaching;

FIG. 5B shows an exemplary prediction output vector from a joint model based prediction engine with jointly predicted demographic/interest information, in accordance with an embodiment of the present teaching;

FIG. 6A illustrates exemplary alternative models for joint prediction of demographic/interest information, in accordance with an embodiment of the present teaching;

FIG. 6B depicts an exemplary multiple layer perceptron neural network architecture for implementing a joint model for joint demographic/interest prediction, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

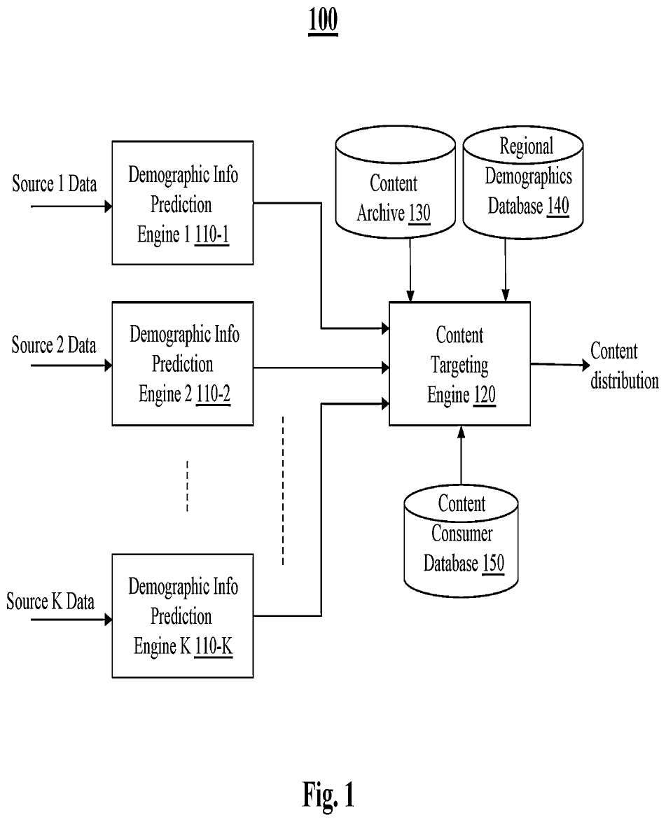

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or systems have been described at a relatively high-level, without detail, in order to avoid unnecessarily obscuring aspects of the present teachings.

The present teaching discloses an exemplary framework for jointly predicting demographic/interest information based on data from different sources via joint modeling and content targeting using such jointly predicted information. Instead of individually predicting different pieces of information, which is not only inefficient but also does not consider the interactions among different data from different platforms/sources, the framework as disclosed herein models the interplay of different pieces and types of data gathered from different platforms for jointly predicting different pieces of demographic/interest information for targeting.

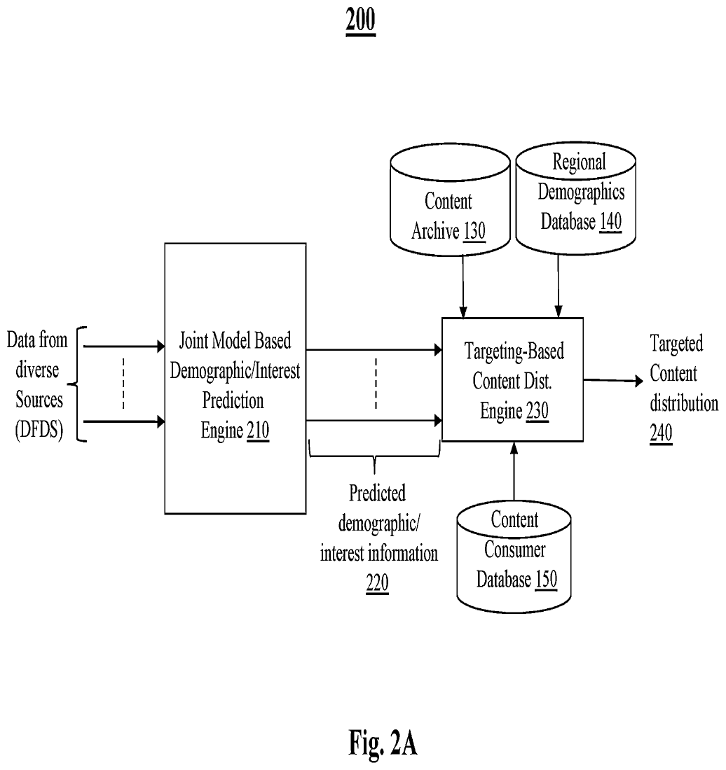

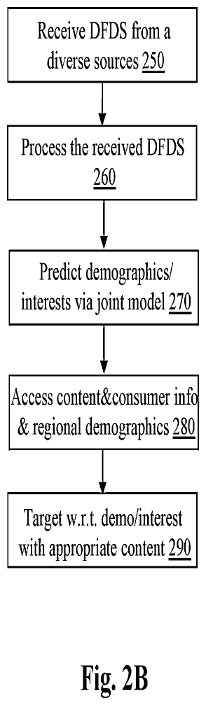

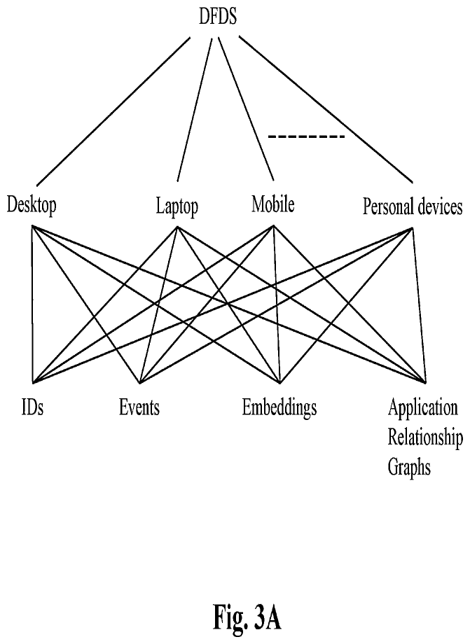

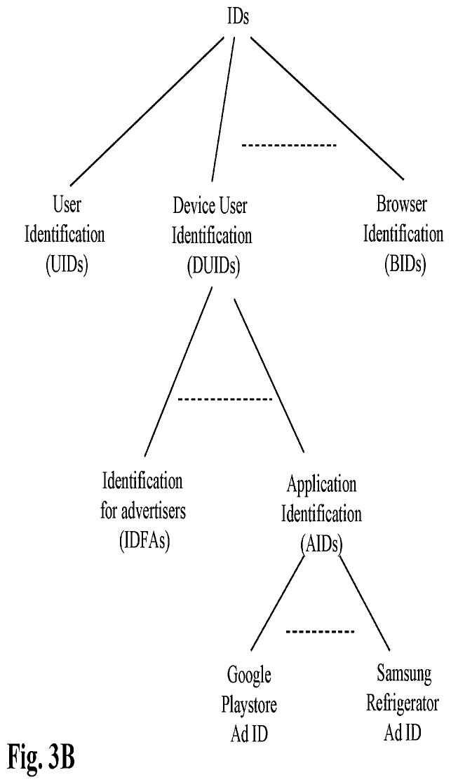

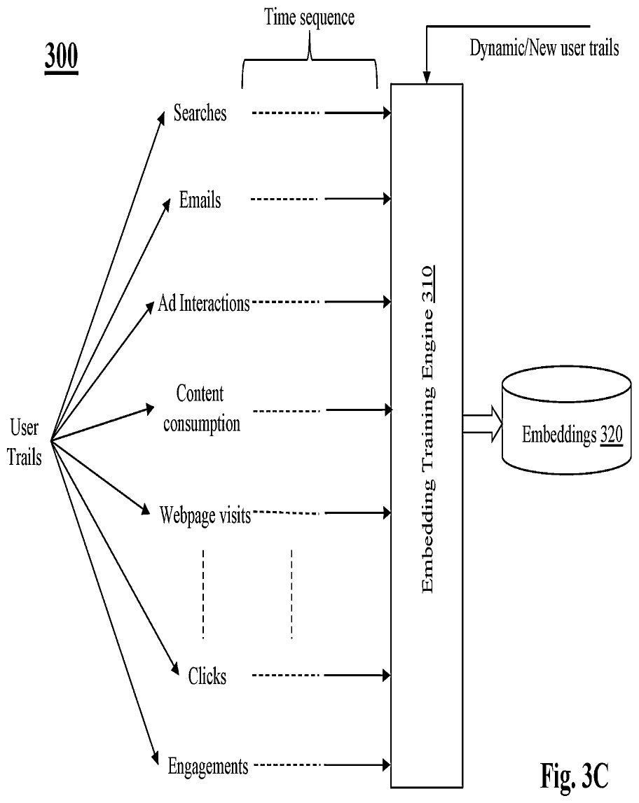

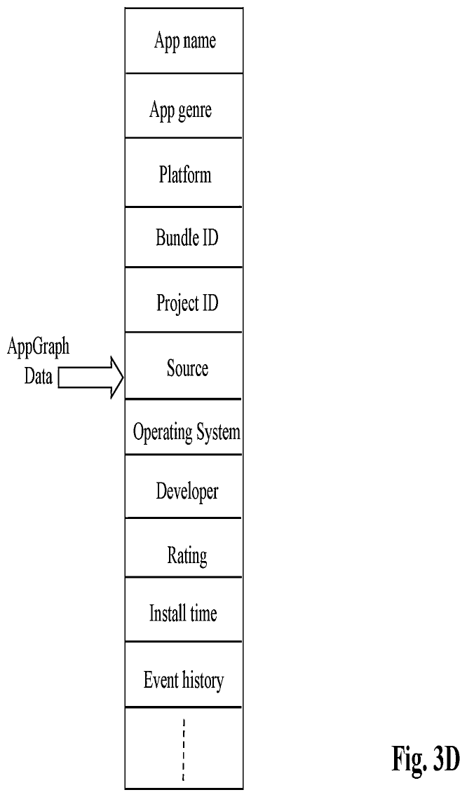

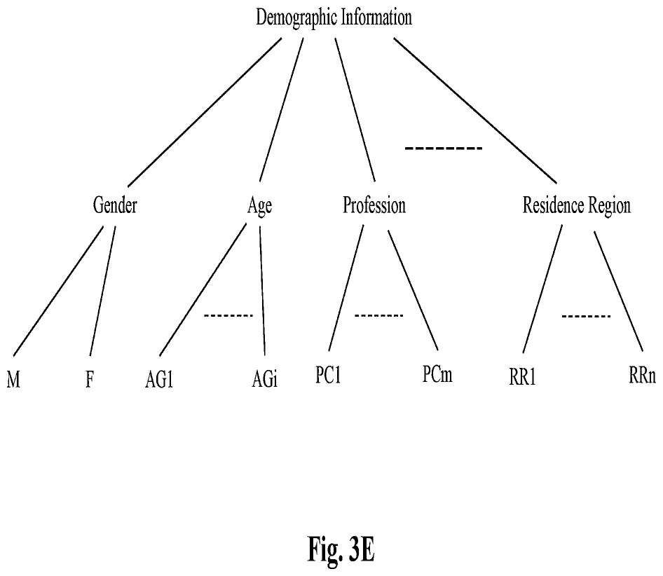

FIG. 2A depicts an exemplary high level system diagram of a content targeting and distribution system 200 based on demographic/interest information jointly predicted based on a joint model, in accordance with an embodiment of the present teaching. In this exemplary framework 200, there are two parts, a first part for simultaneously predicting a plurality pieces of demographic/interest information via joint modeling and a second part for targeted content distribution based on the predicted information. The first part involves a joint model based demographic/interest prediction engine 210 that takes data from a diverse range of sources/platforms and predicts, simultaneously, a plurality pieces of demographic/interest information 220. Details related to the joint model based demographic/interest prediction engine 210 are provided with reference to FIGS. 3A-6B.

The second part of system 200 may include the targeting-based content distribution engine 230 that may be constructed to receive the simultaneously predicted multiple pieces of demographic/interest information 220 and use them to make targeting decisions regarding which content in the content archive 130 is to be distributed to which audiences (optionally at certain preferred dates/times) and then deliver content to different targets accordingly as targeted content distribution 240. The targeting-based content distribution engine 230 may also update, based on the received jointly predicted demographic/interest information, what is archived in the demographics database 140 and/or in the content consumer database 150. In some situations, the received predicted demographic information may be used to update information stored in the regional demographics database 140 and/or the content consumer database 150. For instance, data from different sources may include, e.g., purchases in the winter season of different toys/tools associated with snow and other associated (e.g., by the same account on Amazon) purchases indicative of an interest in a trendy product suitable for children of an age group. Such input may lead to a joint prediction of a presence of a person at a child age in a northern region of the country, which may then be used to update the statistics on demographics in northern regions of the country stored in 140. Such updated information may subsequently allow the targeting-based content distribution engine 230 to enhance its targeting capability.

FIG. 2B is a flowchart of an exemplary process of the content targeting and distribution system 200 based on demographic/interest information jointly predicted based on a joint model, in accordance with an embodiment of the present teaching. When the joint model based demographic/interest prediction engine 210 receives, at 250, data from different sources (DFDA), it processes the received DFDS at 260 and utilized such information to predict, at 270, a plurality pieces of demographic/interest information in accordance with a joint model trained to model how to simultaneously predict multiple demographics/interests. The multiple predicted demographics/interests are then sent to the targeting-based content distribution engine 230 which then combines the previously stored content/consumer information and/or regional demographics, accessed at 280, to make targeting decisions to distribute content to certain audiences that are targeted, at 290, with respect to various demographics/interests, located in different geographical regions.

In order to be able to predict demographic/interest information more accurately under as many different circumstances as possible, the sources of information are diverse, which may include data from different platforms, including, e.g., desktop, laptop, mobile, personal devices (e.g., TV, audio devices, game devices, refrigerators, healthcare equipment, Pods, wearables, etc.) and different sources, such as Yahoo, Google, Amazon, eBay, YouTube, Apple, Samsung, GE, Tesla, GM, car dealerships, etc. Data related to each source (e.g., Amazon) may be collected with respect to different platforms of the same source (e.g., laptop and mobile). Data from each source may include different types, some of which may be actual data and some of which may also be processed or even transformed.

FIG. 3A illustrates exemplary types of DFDS that may be used for joint model based prediction, in accordance with an embodiment of the present teaching. As discussed herein, DFDS may span across different platforms, e.g., desktop, laptop, mobile, . . . , and personal devices. Each platform may involve different sources (not shown) and from each of such sources, a variety of data may be collected. Each platform may provide data with respect to different types of user identification and data about different types of events. FIG. 3B shows exemplary types of identification data from different sources on different platforms that may be used for joint model based prediction, in accordance with an embodiment of the present teaching. As illustrated, identifications may include a user identification (UID), a device user identification (DUIDs), . . . , or a browser identification (BIDs).

A UID may refer to an identification when a user logs on to a service provider (e.g., Yahoo's user logs on to Yahoo email service). A BID may refer to an identification used by a browser when a user connects to the browser. Such a BID may be created based on various fingerprint information associated with the user, including, e.g., user's agent (e.g., ISP address), operating system (iOS), settings, windows, screen, etc. A DUID may refer to an identification for a device on which a user may be operating. A DUID may correspond to what a service provider sees. For instance, an advertiser delivering an advertisement to mobile devices may “see” which devices (represented by corresponding UDIDs) clicked on the advertisement. Similarly, providers of services via applications running on devices may also “see” activities conducted on different devices recognized by their corresponding UDIDs. For instance, a Google Playstore application may be associated with an advertisement identification so that any activities occurred within Google Playstore application may be recognized via the UDID associated therewith. Each of Samsung's refrigerators that provide an Internet connection may be identified with a UDID and any activity performed by a member of a family with such a refrigerator may be observed and collected under the UDID associated with the refrigerator.

Some intermediate data created based on native information collected from different platforms may be generated and used as input to the joint model based demographic/interest prediction engine 210. For example, as illustrated in FIG. 3A, embeddings as well as application relationship graphs may be used as input for performing joint model based prediction of demographics/interests. These may correspond to results of processing some raw data. Embeddings correspond to parameters of a mechanism that, once trained, may be used to generate an output, representing, e.g., a feature vector. That is, the mechanism with trained embeddings may take data in a certain dimension as input and then generate an output vector with attributes characterizing the input in a different dimension. Such embeddings may be derived via training and the trained embeddings may be provided as a service. This is shown in FIG. 3C, with an exemplary depiction of an exemplary framework 300 for generating embeddings for joint model based prediction and dynamic update thereof, in accordance with an embodiment of the present teaching.

As shown in FIG. 3C, different types of data representing user trails from different sources may be used as input. This may include search records, emails, interactions with advertisements, content consumed, recorded webpage visits, . . . , clicks with respect to either content or advertisements, . . . , and engagement measurements, etc. Each category of such input data may correspond to a time sequence and continuous. Such time sequence may also have time stamps so that time may also be a consideration in analyzing the data. These data streams may then be input to an embedding training engine 310 which, utilizing the data for training, produces learned embeddings 320. When the dimension of the output produced using the embeddings is smaller than the dimension of the input user trail data, the mechanism using the learned embeddings may also achieve dimension reduction.

In some embodiments, as input data continues to be generated, embeddings may be dynamically updated. That is, dynamic user trails may continue to be utilized by the embedding training engine 310 to adapt the embedding to the dynamics of the collected data. For example, if embeddings are initially trained based on historic input data collected in connection with a set of users, such embeddings may need to be updated subsequently in order to continue to capture the characteristics of the subsequent input data. In some embodiments, input may include data related to some user trails of those users who appear for the first time. The previously learned embeddings may be used to characterize the features of the new users. Such data of new user trails may be included by the embedding training engine 310 so that to adapt the embeddings to an enlarged group of users.

As discussed herein, the DFDS may also include input data that capture, e.g., with respect to different devices (e.g., mobile phones, pads, laptops, or computers), data associated with applications such as installation of applications, classifications of such applications, the device platforms, events occurred on the devices, etc. Such data may also be utilized to estimate, in combination with other data, demographics/interests of the users who used such applications. FIG. 3D illustrates exemplary types of dynamic information related to applications and usage thereof with respect to devices for joint model based prediction, in accordance with an embodiment of the present teaching. In this illustration, the captured data include name of each application, its genre, a platform on which the application is deployed, identifications for bundle/project of the application, a source of the application such as the developer of the application, the operating system under which the application is deployed, a rating of the application, an installation time of the application, events associated with the applications, and if applicable, may be a deletion time of the application.

Such information related to applications may be used to build relationships between and among applications which may evolve over time. For instance, on some device, the migration of applications (installations and deletions) and their levels of activities may be used as an indication of change of interests. The evolvement of applications (installment and usage levels) over time may also be indicative of certain demographic characteristics. For instance, the migration of applications on a device may follow a pattern of a trend of a group of people in a certain age group. Thus, a representation (such as a graph) capturing the dynamics of applications' installation, usage level, activities therein, peak usage time, valley usage time, correlation with other application usage patterns, etc. may be established and used as part of the DFDS input to the joint model based demographic/interest prediction engine 210.

FIG. 3E illustrates exemplary types of demographics that may be jointly and simultaneously predicted based on a joint prediction model, in accordance with an embodiment of the present teaching. As illustrated, different kinds of demographics may be estimated by considering different types of input data in the DFDS, including gender, age, profession, . . . , or residence region. The gender information, e.g., may be coded as a binary output with one state indicating one gender status and zero representing the opposite gender. Although age may have many different values and may be difficult to predict the specific age, age group prediction may be feasible. That is, there may be different age groups (AG) such as AG1, AG2, . . . , AGi, as shown in FIG. 3E. The age groups may be defined based on, e.g., some criteria such as each age group may be known to exhibit some shared characteristics so that people in the same age group may be targeted in the same way.

From DFDS input, demographic information related to professions may also be estimated. While there may be many professions, it may not be feasible to predict each and every profession so that some taxonomy on professions may be appropriately obtained to derive different profession categories (PC), e.g., PC1, PC2, . . . , PCm, as illustrated in FIG. 3E. Similarly, residence of a user is also an important piece of demographic information. For instance, if a person is estimated to live in a northern region, this information is relevant in targeting, e.g., the person should not be targeted with swimming suit in Christmas promotions. Residence information may also be predicted based on DFDS. For instance, if there is a repeated pattern that a user visits websites on flowers each spring with a much more increased click activities, it may be estimated that the person lives in a region that has 4 seasons. Residence may be estimated based on some defined geographical regions such as north, south, east, or west, as well as city, suburbs, or countryside. The resolutions may be application dependent, and the predictions may be directed to some defined residence regions (RR) such as RR1, RR2, . . . , RRn, segmented according to some criteria determined based on application needs. Another significant category of DFDS data relates to event data, which may record a wide range of activities such as visits, clicks, dwell time, frequency of visits, time spent on application each day, idle time, etc. Such data may depict the attention direction and hence, reflect certain level of interest in something.

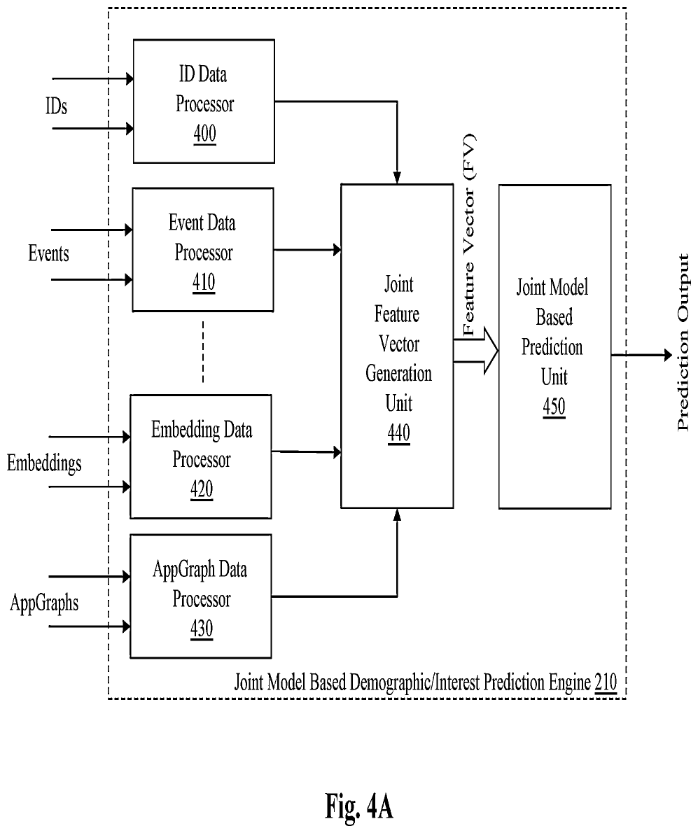

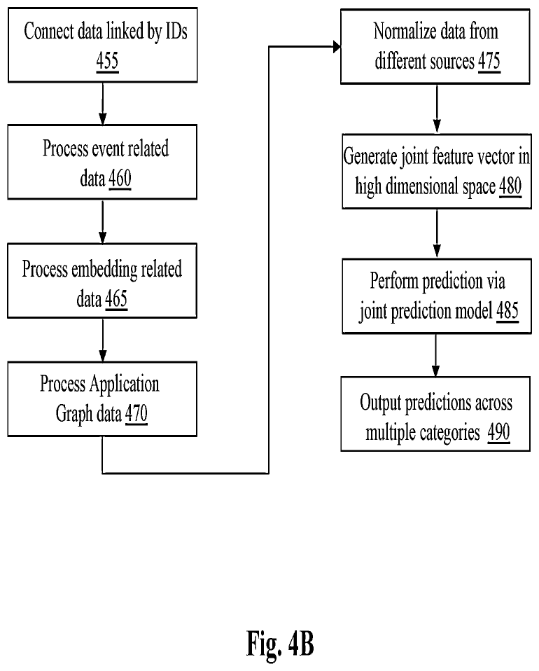

FIG. 4A depicts an exemplary high level system diagram of the joint model based demographic/interest prediction engine 210, in accordance with an embodiment of the present teaching. In this illustrated embodiment, the joint model based demographic/interest prediction engine 210 comprises a plurality of processors, including an ID data processor 400, an event data processor 410, an embedding data processor 420, . . . , and an application graph data processor 430. Each of the processors may be directed to a different type of DFDS. Data in each category may include some identification that can be used to connect data related to the same user but collected in different categories. For example, a user may use a desktop and a smart phone to connect to the network and conduct activities on both platforms. Such activity data may be collected as input to the joint model prediction engine 210. Although such data may be collected separately from different platforms, some identification may be used to link the data on different platforms as directed to the same user.

DFDS input may need to be processed prior to being used for feature extraction and model based prediction. For instance, data from different sources/platforms may need to be normalized, some non-numerical data from different sources/platforms may need to be coded into values in a numerical range, etc. For example, some platforms may allow users to rate certain applications in a scale of 1-10, while others may use a different scale of 1-5. In this case, the rating from users may be rescaled and normalized so that all rating related data may be recorded using a uniform scale without changing the relative evaluations from different users. This ranking example may also be used to illustrate the conversion from non-numerical data to numerical data. If the ranking on some platform uses non-numerical evaluation scores such as A, B, C, and D, these ratings may also need to be converted to numerical ranking scores in a specified range, e.g., 1-10. Such processed data may then be provided to a joint feature vector generation unit 440 to generate feature vectors of the DFDS based on the processed input. The feature vector is then sent to a joint model based prediction unit 450, which then generates a prediction output with predicted demographics/interests as discussed herein.

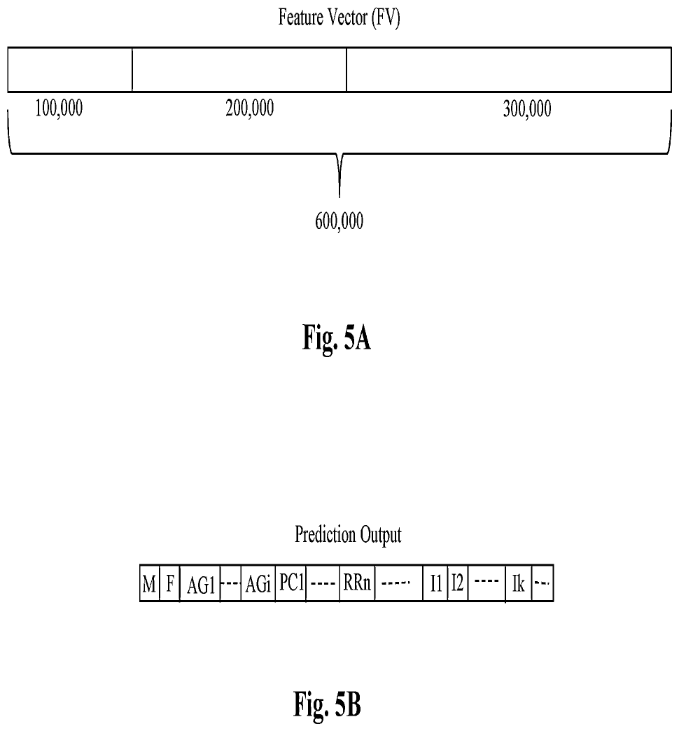

Due to the amount of input data included in DFDS, the feature vector generated by the joint feature vector generation unit 440 may be high dimensional. In some embodiments, the dimensionality of a feature vector obtained based on DFDS may be in a range of several hundreds of thousands. FIG. 5A illustrates an exemplary high dimensional feature vector (FV) with attributes associated with different data types from different sources, in accordance with an embodiment of the present teaching. In this example, the dimensionality of the feature vector is 600,000, with the first portion of 100,000 dimension relating to data from a first source, the second portion of 200,000 dimension relating to data from a second source, and a third portion of 300,000 dimension generated based on data from a third source. Thus, the total dimensionality of this example feature vector amounts to 600,000. In some embodiments, if embeddings are available with a dimensionality 100, trained based on certain portion of the input data, e.g., the first portion in the exemplary feature vector with 100,000 dimensions, then the embeddings may be used to map the first 100,000 dimensions to a 100-dimensional sub-vector so that the overall dimensionality of the feature vector may be reduced to 500,100.

FIG. 5B shows an exemplary prediction output from the joint model based demographic/interest prediction engine 210 with simultaneously predicted demographic/interest information, in accordance with an embodiment of the present teaching. As the joint model based approach enables simultaneous prediction, the exemplary output as shown in FIG. 5B may correspond to a vector with attributes therein as predicted demographics/interests. In this example, the prediction output may comprise a plurality of predicted demographics and/or a plurality of predicted interests. The predicted demographics may include attributes representing gender (M and F or simply one binary attribute with one value indicating female and the other value indicating male), different age groups AGs (i.e., AG1, AG2, . . . , AGi), different professional categories PCs (i.e., PC1, PC2, . . . , PCm), . . . , and residence regions RRs (i.e., RR1, . . . , RRn), etc. The predicted interests may include attributes representing defined interest groups such as I1, I2, . . . , Ik. Similarly, different interest groups may be defined based on some taxonomy so that interests may be categorized.

FIG. 4B is a flowchart of an exemplary process of the joint model based demographic/interest prediction engine 210, in accordance with an embodiment of the present teaching. In operation, upon receiving the DFDS input, the ID data processor 440 in the joint model based demographic/interest prediction engine 210 may connect, at 455, the received input data that correspond to the same user identification. The connected data may be from one or more platforms/sources. In this manner, the connected data may then be processed as data belonging to the same user. Different categories of DFDS input data may then be processed. For instance, event related data may be processed by the event data processor 410 at 460; embedding related data may be processed by the embedding data processor 420 at 465; the application graph related data may be processed by the AppGraph data processor 430 at 470.

The diverse DFDS input data may be further processed in order to generate a joint feature vector. As discussed here, for example, data form may be unified to have numerical values and such values may be normalized, at 475, before the joint feature vector generation unit 440 creates, at 480, a joint feature vector with respect to, e.g., each group of connected DFDS input data under the same user identification. In this manner, a joint feature vector for each user identification is obtained to include data related to the user from different platforms/sources and can be used to predict the demographic/interest characteristics of the user.

With a joint feature vector created for each user, the joint model based prediction unit 450 performs, at 485, simultaneous prediction of demographics/interests of the user in accordance with a joint prediction model. As illustrated in FIG. 5B, the jointly predicted demographics/interests may be output as a prediction vector with attributes therein corresponding to different predicted demographics/interests. For each joint feature vector created based on grouped DFDS associated with the same user identification, a prediction vector may be generated representing the demographics and interests of the underlying user. Such prediction vectors generated via a joint model may then be output, at 490, to the targeting-based content distribution engine 240 (see FIG. 2A) so that they may be utilized for conducting targeted content distribution. As discussed herein, the predicted demographics/interests in each prediction vector for a user may be used (e.g., by the targeting-based content distribution engine 240) to update the regional demographics database 140 and/or the content consumer database 150 to adapt the recorded information to the dynamics of the marketplace to improve the quality of targeted content distribution.

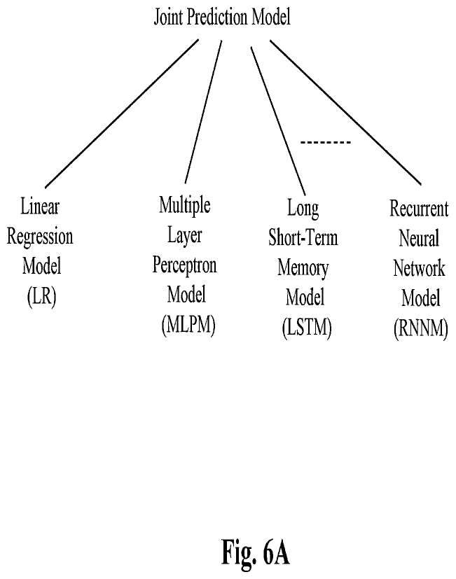

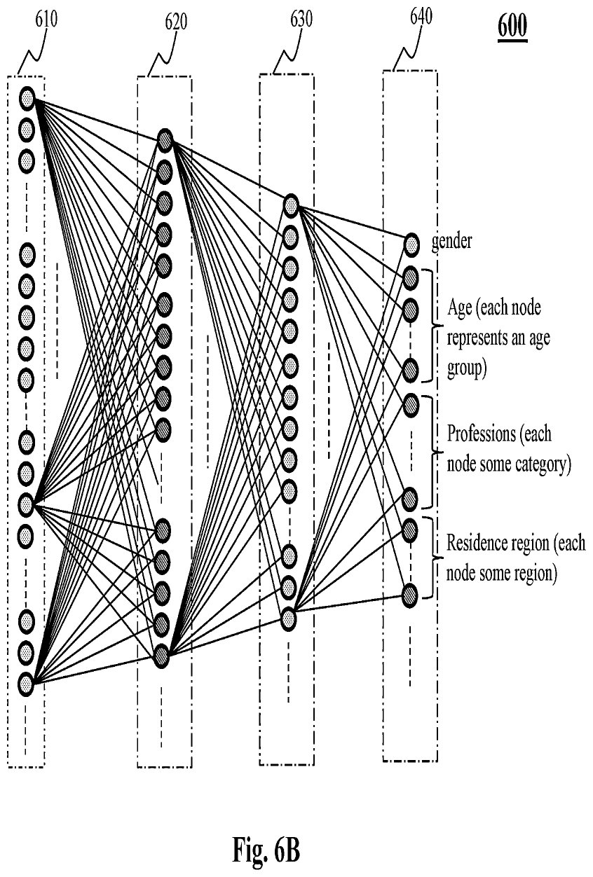

As disclosed herein, the joint model based demographics/interests' prediction may be achieved via a joint model developed based on training data. Different modeling approaches may be utilized to develop a joint model. FIG. 6A illustrates exemplary alternative models that may be used for joint prediction of demographic/interest information, in accordance with an embodiment of the present teaching. In this illustration, alternative models that may be utilized for training to jointly predict demographics/interests based on DFDS may include a linear regression model (LR), a multiple layer perceptron model (MLPM), a long short-term memory model (LSTM), . . . , and recurrent neural network model (RNNM). It is noted that these exemplary alternative models pre provided for illustration and it is not intended for restricting the scope of the present teaching. Any model, whether past developed or future explored, that may be trained for simultaneously predicting multiple demographics/interests is within the scope of the present teaching.

FIG. 6B depicts an exemplary multiple layer perceptron neural network architecture 600 for achieving a joint model for joint demographic/interest prediction, in accordance with an embodiment of the present teaching. In this example, a 4 layers MLPM is provided with an input layer 610, a first intermediate layer 620, a second intermediate layer 630, and an output layer 640. The input layer 610 may be provided to take input joint feature vector generated for each user and includes neurons connecting to a joint feature vector and neurons of the first intermediate layer 620. For example, each neuron in the input layer 610 may be connected to a corresponding attribute of the joint feature vector and to each and every node or neuron in the first intermediate layer 620. The number of neurons in the input layer may be the number of attributes of a joint feature vector. For example, the input layer 610 may have 600,000 neurons corresponding to the exemplary 600,000 dimensions of a joint feature vector as discussed herein.

In some embodiment as illustrated, the input layer 610 and the first intermediate layer 620 may be fully connected in a forward direction, i.e., each input neuron is connected to all the neurons in the first intermediate layer 620, as shown in FIG. 6B. Similarly, the first intermediate layer 620 may be fully connected with the second intermediate layer 630 in a forward direction, i.e., each neuron in the first intermediate layer 620 is connected to all neurons in the second intermediate layer 630, as shown in FIG. 6B. In this example, the second intermediate layer 630 may also be fully connected with the output layer 640 in a forward direction, as shown. In this architecture, each neuron may have a function to perform with adjustable parameter(s).

The links connecting any two neurons in FIG. 6B may be weighted with an adjustable weight as a learnable parameter. There may be other learnable parameters as well. For instance, each neuron in the MLPM 600 may correspond to a mapping or transformation function which may be formulated based on learnable parameter(s). Values of such learnable parameters may be adjusted during training while the joint model is learning how to simultaneously predict multiple demographic/interest information. In some embodiments, the learning of the joint model may be achieved based on training data in an iterative manner. The learnable parameters (model parameters) may be adjusted during iteration based on an assessment against some objective function and a convergence condition provided for controlling the learning process. In each iteration, the convergence condition may be evaluated based on a loss computed based on a discrepancy between the demographic/interest predictions using the joint model and the corresponding ground truth demographics/interests provided in the training data. If the convergence condition is not met (e.g., the loss is above a level specified in the convergence condition), the loss during this iteration may be used to determine the adjustments to the learnable parameters. The adjustments may be made to drive the learning process towards convergence, i.e., to satisfy the specified convergence condition. With the updated model parameters, the joint model is being trained to behave differently in the next iteration. Such an iterative training process repeats until the convergence condition is satisfied (e.g., the loss is below a certain level as specified in the convergence condition). At that point, the MLPM 600 corresponds to a learned joint model and may be used to simultaneously predict multiple pieces of demographic/interest information with a performance similar to what the ground truth training data exhibits.

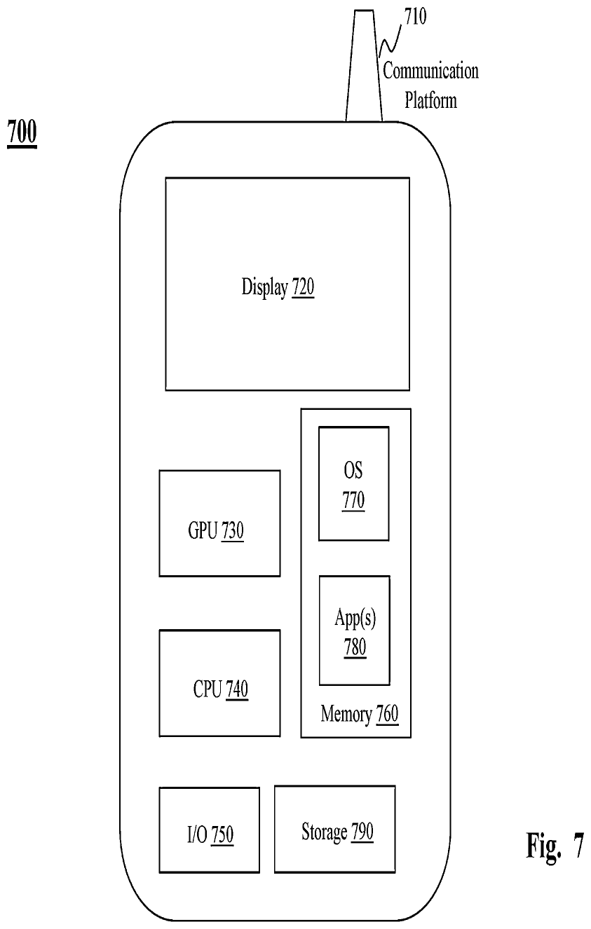

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handheld gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

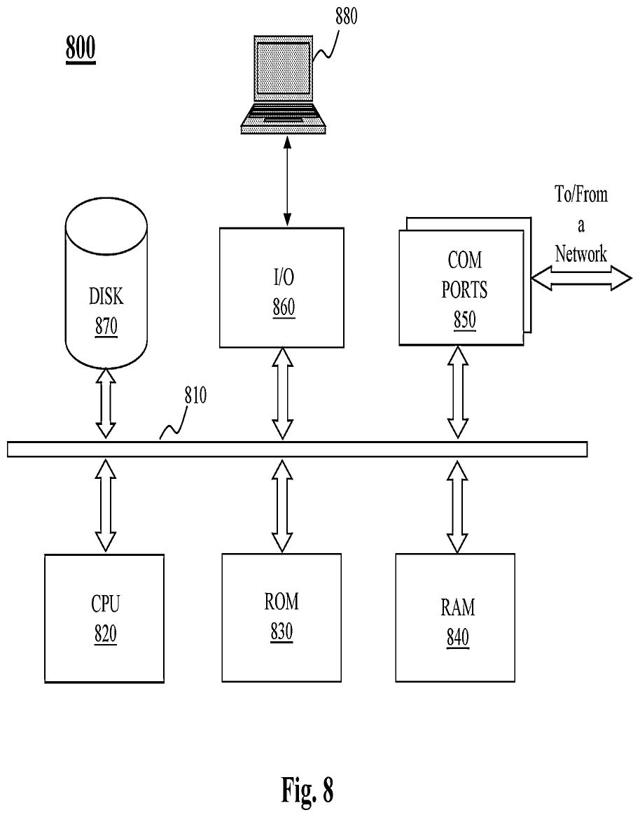

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for joint prediction, comprising:
obtaining training data including information relating to a plurality of users collected from different sources and ground truth demographics/interests associated with each of the plurality users;
training a joint prediction model via machine learning based on the training data, wherein the joint prediction model is for simultaneously predicting multiple pieces of demographic/interest information;
receiving information about a user collected from different sources;
obtaining a joint feature vector based on the information about the user;
predicting, using the trained joint prediction model, multiple pieces of demographic/interest information of the user based on the joint feature vector.

2. The method of claim 1, wherein the different sources include:
a plurality of platforms including desktop computers, laptop computers, mobile devices, and personal devices; and
a plurality of applications operating on the plurality of platforms, wherein
the personal devices include at least one of a television, a refrigerator, an audio device, and a video device.

3. The method of claim 1, wherein the joint prediction model is configured with a plurality of learnable parameters with values adjusted during training, wherein an adjustment to each of the plurality of parameters is based on a discrepancy between the ground truth demographics/interests of each of the plurality of users and multiple pieces of demographic/interest information of the user predicted by the joint prediction model.

4. The method of claim 3, wherein the joint prediction model is trained in an iterative learning process, set up with a convergence condition and an objective function, wherein
the convergence condition is used for determining when the joint prediction model converges; and
the objective function is provided for determining the value adjustments to the learnable parameters by minimizing the discrepancy.

5. The method of claim 2, wherein the information relating to a plurality of users collected from different sources includes:
identifications used in connection with the plurality of platforms and the plurality of applications for identifying the plurality of users;
event data recording activities of the plurality of users conducted with respect to the plurality of applications operating on the plurality of platforms;
embeddings obtained via machine learning based on training data comprising trails of the plurality of users, wherein the embeddings are for mapping information related to each of the plurality of users to a vector to characterize the user; and
application graphs each of which characterizes usage of a set of applications by each of the plurality of users, wherein each of the set of applications operates on one of the plurality of platforms.

6. The method of claim 1, wherein the multiple pieces of demographic/interest information of the user simultaneously predicted by the joint prediction model include at least two of:
gender;
an age predicted as one of a plurality of age groups;
a residence region predicted as one of a plurality of residence regions; and
a profession predicted as one of a plurality of professional categories.

7. The method of claim 1, wherein further comprising distributing content via targeting based on demographics/interests by:
accessing the content with a description associated therewith;
obtaining, based on the description, one or more targeting criteria specifying demographics and/or interests of intended recipients of the content;
determining an affinity of each of multiple users with the demographics and/or interests of intended recipients based on the multiple demographic/interest information of the user predicted using the joint prediction model;
selecting one or more target users based on their respective affinities that meet the one or more targeting criteria; and
transmitting the content to the selected one or more target users.

8. Machine readable and non-transitory medium having information recorded thereon for joint prediction, wherein the information, when read by the machine, causes the machine to perform the following steps:
obtaining training data including information relating to a plurality of users collected from different sources and ground truth demographics/interests associated with each of the plurality users;
training a joint prediction model via machine learning based on the training data, wherein the joint prediction model is for simultaneously predicting multiple pieces of demographic/interest information;
receiving information about a user collected from different sources;
obtaining a joint feature vector based on the information about the user;
predicting, using the trained joint prediction model, multiple pieces of demographic/interest information of the user based on the joint feature vector.

9. The medium of claim 8, wherein the different sources include:
a plurality of platforms including desktop computers, laptop computers, mobile devices, and personal devices; and
a plurality of applications operating on the plurality of platforms, wherein
the personal devices include at least one of a television, a refrigerator, an audio device, and a video device.

10. The medium of claim 8, wherein the joint prediction model is configured with a plurality of learnable parameters with values adjusted during training, wherein an adjustment to each of the plurality of parameters is based on a discrepancy between the ground truth demographics/interests of each of the plurality of users and multiple pieces of demographic/interest information of the user predicted by the joint prediction model.

11. The medium of claim 10, wherein the joint prediction model is trained in an iterative learning process, set up with a convergence condition and an objective function, wherein
the convergence condition is used for determining when the joint prediction model converges; and
the objective function is provided for determining the value adjustments to the learnable parameters by minimizing the discrepancy.

12. The medium of claim 9, wherein the information relating to a plurality of users collected from different sources includes:
identifications used in connection with the plurality of platforms and the plurality of applications for identifying the plurality of users;
event data recording activities of the plurality of users conducted with respect to the plurality of applications operating on the plurality of platforms;
embeddings obtained via machine learning based on training data comprising trails of the plurality of users, wherein the embeddings are for mapping information related to each of the plurality of users to a vector to characterize the user; and
application graphs each of which characterizes usage of a set of applications by each of the plurality of users, wherein each of the set of applications operates on one of the plurality of platforms.

13. The medium of claim 8, wherein the multiple pieces of demographic/interest information of the user simultaneously predicted by the joint prediction model include at least two of:
gender;
an age predicted as one of a plurality of age groups;
a residence region predicted as one of a plurality of residence regions; and
a profession predicted as one of a plurality of professional categories.

14. The medium of claim 8, wherein the information, when read by the machine, further causes the machine to perform the step of distributing content via targeting based on demographics/interests by:
accessing the content with a description associated therewith;
obtaining, based on the description, one or more targeting criteria specifying demographics and/or interests of intended recipients of the content;
determining an affinity of each of multiple users with the demographics and/or interests of intended recipients based on the multiple demographic/interest information of the user predicted using the joint prediction model;
selecting one or more target users based on their respective affinities that meet the one or more targeting criteria; and
transmitting the content to the selected one or more target users.

15. A system for joint prediction, comprising:
a joint model based demographic/interest prediction engine implemented by a processor and configured for:
obtaining training data including information relating to a plurality of users collected from different sources and ground truth demographics/interests associated with each of the plurality users,
training a joint prediction model via machine learning based on the training data, wherein the joint prediction model is for simultaneously predicting multiple pieces of demographic/interest information,
receiving information about a user collected from different sources,
obtaining a joint feature vector based on the information about the user, and
predicting, using the trained joint prediction model, multiple pieces of demographic/interest information of the user based on the joint feature vector.

16. The system of claim 15, wherein the different sources include:
a plurality of platforms including desktop computers, laptop computers, mobile devices, and personal devices; and
a plurality of applications operating on the plurality of platforms, wherein
the personal devices include at least one of a television, a refrigerator, an audio device, and a video device.

17. The system of claim 15, wherein the joint prediction model is configured with a plurality of learnable parameters with values adjusted during training, wherein an adjustment to each of the plurality of parameters is based on a discrepancy between the ground truth demographics/interests of each of the plurality of users and multiple pieces of demographic/interest information of the user predicted by the joint prediction model.

18. The system of claim 17, wherein the joint prediction model is trained in an iterative learning process, set up with a convergence condition and an objective function, wherein
the convergence condition is used for determining when the joint prediction model converges; and
the objective function is provided for determining the value adjustments to the learnable parameters by minimizing the discrepancy.

19. The system of claim 16, wherein the information relating to a plurality of users collected from different sources includes:
identifications used in connection with the plurality of platforms and the plurality of applications for identifying the plurality of users;
event data recording activities of the plurality of users conducted with respect to the plurality of applications operating on the plurality of platforms;
embeddings obtained via machine learning based on training data comprising trails of the plurality of users, wherein the embeddings are for mapping information related to each of the plurality of users to a vector to characterize the user; and
application graphs each of which characterizes usage of a set of applications by each of the plurality of users, wherein each of the set of applications operates on one of the plurality of platforms.

20. The system of claim 15, further comprising a targeting-based content distribution engine implemented by a processor and configured for distributing content via targeting based on demographics/interests by:
accessing the content with a description associated therewith;
obtaining, based on the description, one or more targeting criteria specifying demographics and/or interests of intended recipients of the content;
determining an affinity of each of multiple users with the demographics and/or interests of intended recipients based on the multiple demographic/interest information of the user predicted using the joint prediction model;
selecting one or more target users based on their respective affinities that meet the one or more targeting criteria; and
transmitting the content to the selected one or more target users.
